(19) United States
(12) Patent Application Publication
(10) Pub. No.: US 2007/0063963 A1
(43) Pub. Date: Mar. 22, 2007

(54) Backlight for liquid crystal display and lighting control method therefor

(75) Inventors: Tsutomu Nanataki, Toyoake-city (JP); Iwao Ohwada, Nagoya-city (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 11/387,095

(22) Filed: Mar. 22, 2006

Related U.S. Application Data
(60) Provisional application No. 60/719,480, filed on Sep. 22, 2005.

(51) Int. Cl. G09G 3/36

(52) U.S. Cl. 345/102

(57) ABSTRACT

A backlight used for a liquid crystal display including a plurality of liquid crystal display elements arranged in a matrix of n rows and m columns, in which constant-time row scanning is performed in row order to change the optical transmittance of the liquid crystal display elements includes a plurality of electron-emitting elements and a phosphor. Each of the electron-emitting elements is disposed so as to face a liquid crystal display element group including a plurality of adjacent liquid crystal display elements with the phosphor therebetween. An electron emission voltage is applied to electron-emitting elements facing liquid crystal display elements for which the row scanning is completed and whose optical transmittance becomes constant. The electron-emitting elements apply electrons to the phosphor. The phosphor is irradiated with electrons, and emits light to the liquid crystal display elements whose optical transmittance becomes constant.

### BACKGROUND OF THE INVENTION

1. Field of the Invention

The present invention relates to a backlight used for a liquid crystal display in which the optical transmittance is controlled by liquid crystal display elements, thereby switching an image to be displayed, and a lighting control method for the backlight.

2. Description of the Related Art

As known in the related art, a backlight for a liquid crystal display includes a plurality of tubular cold cathode discharge lamps that are arranged parallel to each other, and a diffusion plate and a plurality of diffusion sheets are disposed above the lamps (see, for example, Japanese Unexamined Patent Application Publication No. 2004-235103).

Meanwhile, the liquid crystal display changes the alignment of liquid crystals of liquid crystal display elements, thereby changing the optical transmittance. A certain period of time is required to change the alignment of the liquid crystals. Thus, the liquid crystal display elements cannot change the optical transmittance in an instant. In other words, the optical transmittance changed by the liquid crystal display elements changes stepwise to the desired transmittance for the image to be displayed. In the liquid crystal display using the backlight of the related art, the light from the backlight is also transmitted during the stage in which the transmittance is changing towards the desired transmittance. Therefore, a problem occurs in that the displayed image is blurry.

### SUMMARY OF THE INVENTION

It is an object of the present invention to provide a backlight in which such blurry images on a liquid crystal display can be eliminated or reduced.

In an aspect of the present invention to achieve the aforementioned object, a backlight used for a liquid crystal display including a plurality of liquid crystal display elements arranged in a matrix of n rows and m columns, in which constant-time row scanning is performed for all rows in row order in a frame period to change the optical transmittance of the plurality of liquid crystal display elements, thereby switching an image to be displayed by the plurality of liquid crystal display elements includes an electron-emitting device, a phosphor, and a drive voltage applying circuit.

The electron-emitting device includes a plurality of electron-emitting elements including an emitter section formed of a dielectric material; a lower electrode disposed below the emitter section; and an upper electrode disposed above the emitter section so as to face the lower electrode with the emitter section therebetween, the upper electrode having a plurality of fine through-holes, wherein the electron-emitting elements accumulate a large number of electrons in the emitter section when a predetermined write voltage is applied between the upper electrode and the lower electrode, and emit the electrons accumulated in the emitter section through the fine through-holes from the emitter section when a predetermined electron emission voltage is applied between the upper electrode and the lower electrode, and the electron-emitting elements are arranged in a matrix so that each of the electron-emitting elements faces each of liquid crystal display element groups including a plurality of the liquid crystal display elements of the liquid crystal display that are adjacent to each other.

The phosphor is disposed between the upper electrode of the electron-emitting elements and the liquid crystal display so as to face the upper electrode, the phosphor emitting light toward the liquid crystal display by collisions with electrons.

In a period from the time when the row scanning for one of the liquid crystal display element groups is finished after which the optical transmittance of liquid crystal display elements belonging to the one liquid crystal display element group becomes constant to the time when the row scanning for the one liquid crystal display element group is started next time, the drive voltage applying circuit applies the electron emission voltage to an electron-emitting element in the plurality of electron-emitting elements for a predetermined time, the electron-emitting element facing the one liquid crystal display element group, and applies the Write voltage in a period until the next time when the electron emission voltage is applied again to the electron-emitting element to which the electron emission voltage is applied.

Accordingly, an electron emission voltage is applied to an electron-emitting element that substantially faces liquid crystal display elements whose optical transmittance is constant with the phosphor therebetween. Since a write voltage has been applied to that electron-emitting element, electrons have been accumulated in the emitter section of that electron-emitting element. As a consequence, the phosphor (or a portion of the phosphor) facing the liquid crystal display elements whose optical transmittance is constant is irradiated with electrons, and the phosphor (or the portion of the phosphor) emits light. The light is applied to the liquid crystal display elements whose optical transmittance is constant. It is therefore possible to prevent image blur due to delay of the liquid crystal alignment.

In a preferred embodiment of the present invention, the value n is a multiple of an integer N of 2 or more, the value m is a multiple of an integer M of 2 or more, the liquid crystal display element groups are arranged in a matrix of n/N rows and m/M columns, n/N being given by dividing n by N, m/M being given by dividing m by M, and the drive voltage applying circuit is configured to, in a sub-frame period starting at the time when the row scanning for all of the liquid crystal display elements forming one of the liquid crystal display element groups is completed and ending at the time when a time needed for the row scanning for the n/N rows has elapsed since the starting time, apply the write voltage and the electron emission voltage to the electron-emitting element facing the liquid crystal display element group including the liquid crystal display elements for which the row scanning is to be started at the end of the sub-frame period.

The preferred embodiment corresponds to a case in which the electron-emitting device is configured such that electron-emitting elements are arranged in a matrix of n/N rows and m/M columns. If the time needed for row-scanning one row of liquid crystal display elements is represented by Tg, a frame period Tf is given by n·Tg, and a sub-frame period is given by (N·Tg). In such a sub-frame period, the drive voltage applying circuit applies the write voltage and the electron emission voltage to the electron-emitting element that faces a liquid crystal display element group including the liquid crystal display elements for which the row scanning is to be started at the end of the sub-frame period, and light is emitted from the phosphor (or a portion of the phosphor) facing that electron-emitting element. The liquid crystal display elements irradiated with the light from the phosphor have changed the alignment because a sufficient time has elapsed since the previous row scanning, and the optical transmittance is constant. It is therefore possible to prevent blurring of a displayed image due to delay of the liquid crystal alignment.

In the backlight, preferably, the drive voltage applying circuit is configured to set the write voltage to a voltage according to the optical transmittance of the plurality of liquid crystal display elements belonging to the liquid crystal display element group facing the electron-emitting element to which the write voltage is applied.

Accordingly, an amount of electrons according to the optical transmittance of a plurality of liquid crystal display elements that belong to each liquid crystal display element group are emitted from an electron-emitting element disposed so as to face the liquid crystal display element group. Thus, the phosphor in the portion disposed so as to face the liquid crystal display element group emits an amount of light according to the optical transmittance of the plurality of liquid crystal display elements that belong to the liquid crystal display element group.

Therefore, for example, the phosphor (or a portion of the phosphor) facing a liquid crystal display element group that is to display a dark area of a displayed image emits a smaller amount of light than the phosphor (or a portion of the phosphor) facing a liquid crystal display element group that is to display a bright area of the displayed image. The electron-emitting device and the phosphor allow a reduction in the amount of excessive light to be blocked by the liquid crystal display elements, and a backlight with low power consumption is provided. Further, the liquid crystal display elements block a small amount of light emitted from the phosphor (or a portion of the phosphor) in the dark area of the displayed image, and transmit a large amount of light emitted from the phosphor (or a portion of the phosphor) in the bright area of the displayed image, and an improvement in the contrast of the displayed image can also be achieved.

In another aspect of the present invention, there is provided a lighting control method for the backlight that is performed in the backlight.

### BRIEF DESCRIPTION OF THE DRAWINGS

FIG. 1 is a schematic partial cross-sectional view of a liquid crystal display device according to an embodiment of the present invention;

FIG. 2 is a plan view of a liquid crystal display shown in FIG. 1;

FIG. 3 is a plan view of an electron-emitting device shown in FIG. 1;

FIG. 4 is an enlarged partial cross-sectional view of the liquid crystal display, the electron-emitting device, and a light-emitting section shown in FIG. 1;

FIG. 5 is an enlarged partial plan view of an upper electrode shown in FIG. 4;

FIG. 6 is a diagram showing a state of the electron-emitting element shown in FIG. 4;

FIG. 7 is a voltage-polarization characteristic graph of an emitter section shown in FIG. 4;

FIG. 8 is a diagram showing another state of the electron-emitting element shown in FIG. 4;

FIG. 9 is a diagram showing another state of the electron-emitting element shown in FIG. 4;

FIG. 10 is a diagram showing another state of the electron-emitting element shown in FIG. 4;

FIG. 11 is a diagram showing another state of the electron-emitting element shown in FIG. 4;

FIG. 12 is a diagram showing another state of the electron-emitting element shown in FIG. 4;

FIG. 13 is a graph showing a relationship between a write voltage of the electron-emitting element shown in FIG. 4 (a drive voltage during an electron accumulation period) and the amount of light emission of a phosphor;

FIG. 14 is a graph showing a relationship between an electron emission voltage of the electron-emitting element shown in FIG. 4 (a drive voltage during a lighting period) and the amount of light emission of the phosphor;

FIG. 15 is a circuit diagram of a drive voltage applying circuit of the electron-emitting device shown in FIG. 1;

FIG. 16 is a time chart showing a relationship between row scanning for liquid crystal display elements in the liquid crystal display device shown in FIG. 1 and lighting control for the backlight;

FIG. 17 is a diagram showing lighting control for the backlight according to the present invention;

FIG. 18 is a schematic diagram showing the states, in plan view, of the light-emitting section obtained by the lighting control for the backlight according to the present invention;

FIG. 19 is a graph showing a relationship between a change in the transmittance of the liquid crystal display elements according to the present invention and the lighting period of the light-emitting section (the electron emission period of the electron-emitting device); and

FIG. 20 is a partial cross-sectional view of a modified example of the light-emitting section shown in FIG. 1.

### DESCRIPTION OF THE PREFERRED EMBODIMENTS

Embodiments of a liquid crystal display device to which a backlight and a lighting control method for the backlight according to the present invention are applied will be described with reference to the drawings. In this document, the terms “accumulation of electrons” and “writing of electrons” are synonymously used.

(Structure)

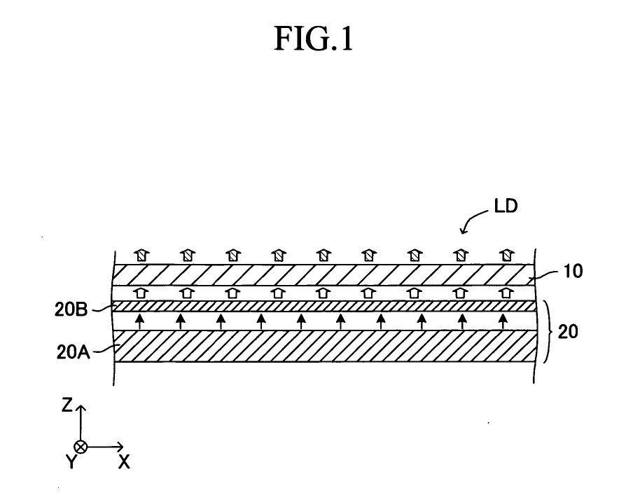

FIG. 1 is a schematic partial cross-sectional view of a liquid crystal display device LD. The liquid crystal display device LD includes a liquid crystal display 10 and a backlight 20. The liquid crystal display 10 is disposed above the upper surface of the backlight 20 (in the positive Z-axis direction).

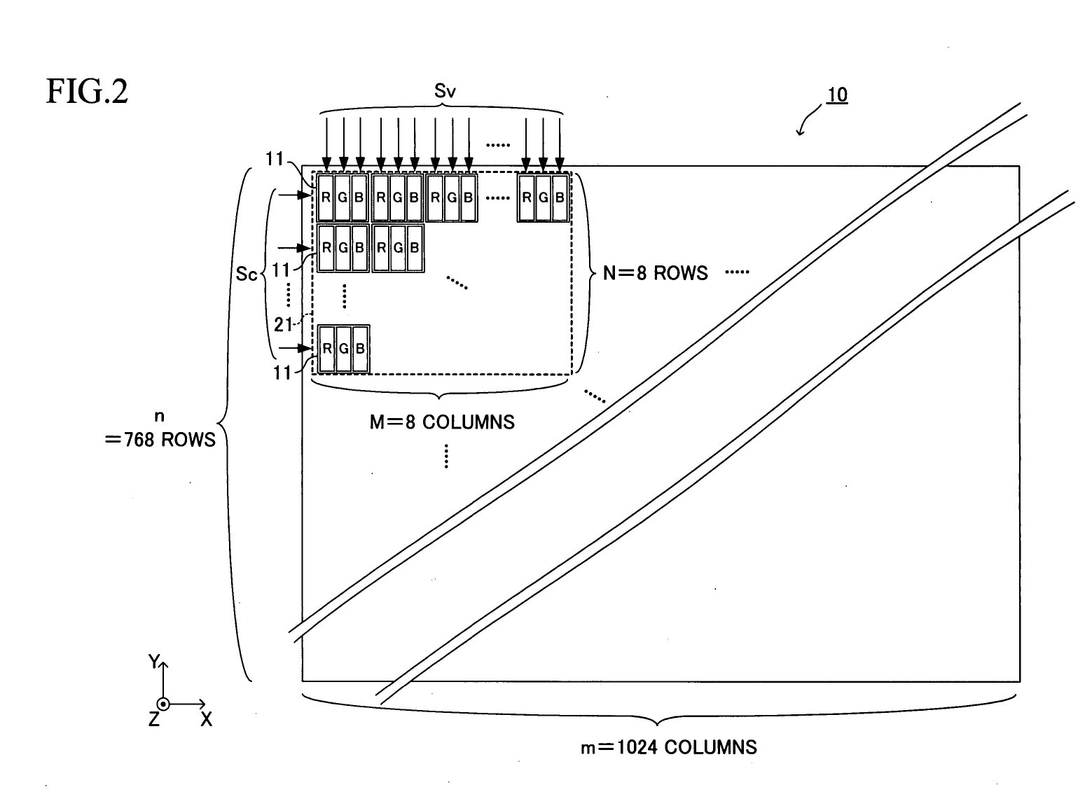

FIG. 2 is a plan view of the liquid crystal display 10. The shape of the liquid crystal display 10 in plan view is rectangular. The liquid crystal display 10 is a known liquid crystal display in which liquid crystal display elements 11 are arranged in a matrix of 768 rows (n rows) and 1024 columns (m columns). Each of the liquid crystal display elements 11 is composed of a red liquid crystal element R, a green liquid crystal element G, and a blue liquid crystal element B.

The red liquid crystal element R is provided with a red filter for transmitting red light included in white light, and is adapted to change the transmittance of red light transmitted through the red filter by alignment control. The green liquid crystal element G is provided with a green filter for transmitting green light included in white light, and is adapted to change the transmittance of green light transmitted through the green filter by alignment control. The blue liquid crystal element B is provided with a blue filter for transmitting blue light included in white light, and is adapted to change the transmittance of blue light transmitted through the blue filter by alignment control.

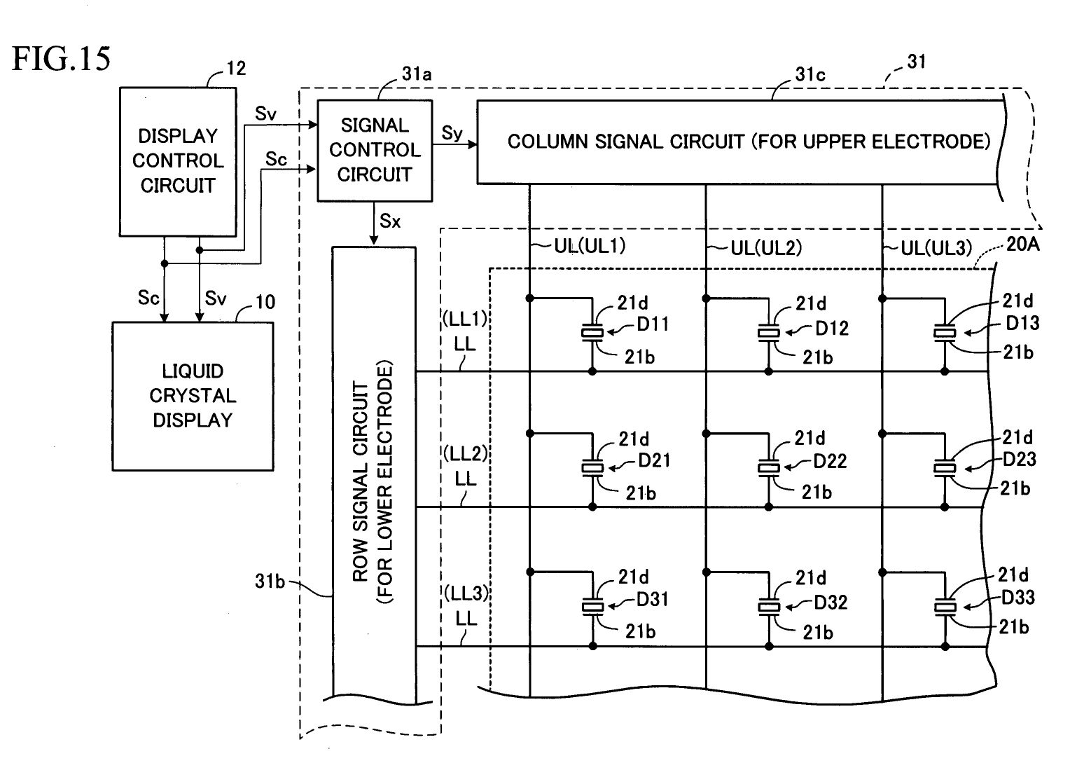

A row scanning signal (row selecting signal) Sc is fed to the liquid crystal display elements 11 belonging to an identical row from a display control circuit (not shown) (see FIG. 15). An image control signal Sv corresponding to each of the red liquid crystal element R, the green liquid crystal element G, and the blue liquid crystal element B is fed to the liquid crystal display elements 11 belonging to an identical column from the display control circuit.

As shown in FIG. 1, the backlight 20 is composed of an electron-emitting device 20A, and a light-emitting section 20B disposed above the electron-emitting device 20A.

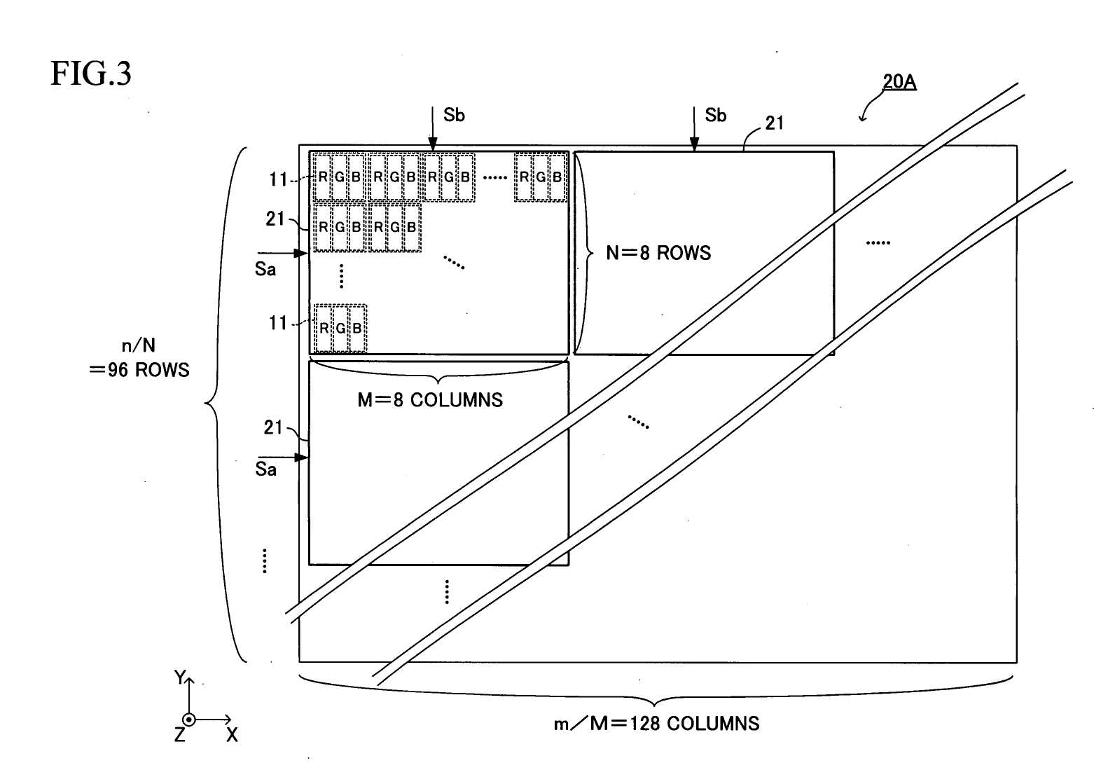

The electron-emitting device 20A is provided with a plurality of electron-emitting elements 21, as shown in FIGS. 2 and 3. FIG. 3 is a plan view of the electron-emitting device 20A. Each of the electron-emitting elements 21 is disposed so as to face a liquid crystal display element group composed of a plurality of liquid crystal display elements 11 arranged in a matrix of 8 rows (N rows) and 8 columns (M columns) (namely, 64 liquid crystal display elements 11). That is, the plurality of electron-emitting elements 21 are arranged in a matrix of 96 rows (=n/N rows) and 128 columns (=m/M columns).

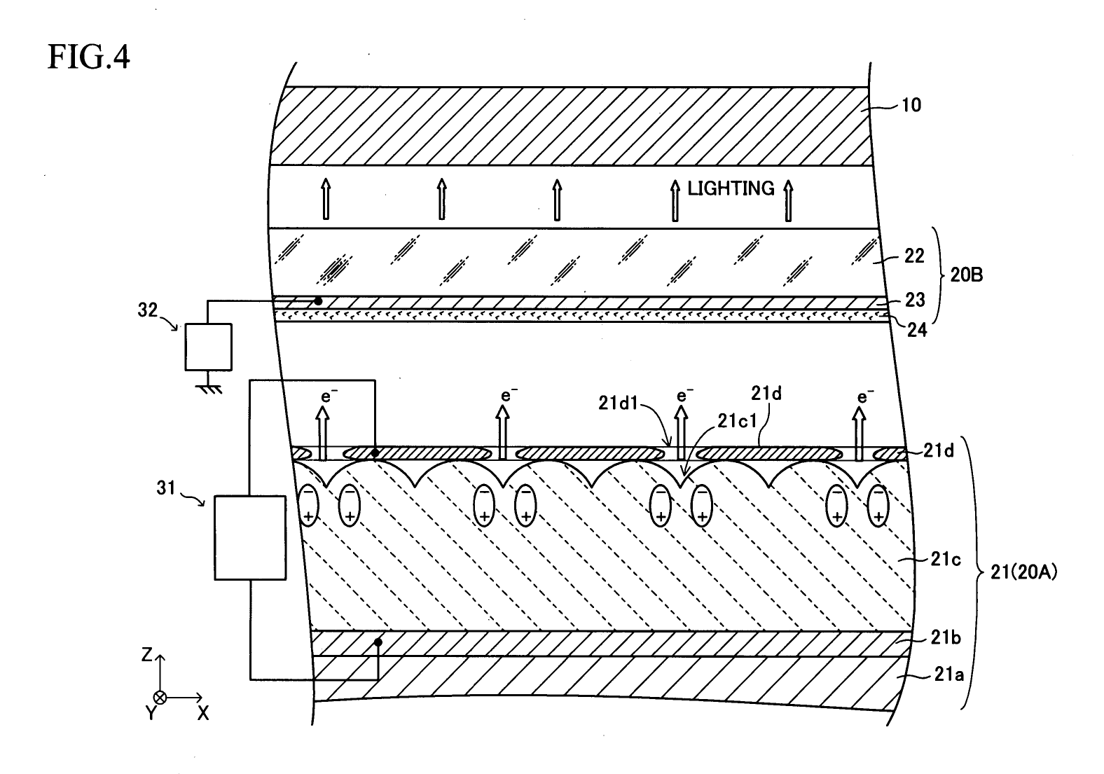

FIG. 4 is an enlarged partial cross-sectional view of the liquid crystal display 10, the electron-emitting device 20A, and the light-emitting section 20B. As shown in FIG. 4, the electron-emitting elements 21 of the electron-emitting device 20A are composed of a substrate 21a, a lower electrode (lower electrode layer) 21b, an emitter section 21c, and an upper electrode (upper electrode layer) 21d.

The substrate 21a is a thin plate having an upper surface and a lower surface that are parallel to a plane (X-Y plane) defined by orthogonal X- and Y-axes, the thickness direction of the plate corresponding to the Z-axis direction, the Z-axis being orthogonal to both the X- and Y-axes. The shape of the substrate 21a in plan view is rectangular, which is substantially the same as the liquid crystal display 10. The substrate 21a is formed of, for example, glass or a ceramic material (preferably, a material containing zirconium oxide as a major component).

The lower electrode 21b is formed of an electrically conductive material (here, silver or platinum), and is disposed in the form of a layer on the upper surface of the substrate 21a. The shape of the lower electrode 21b in plan view is a strip with a long side extending in the X-axis direction. The length of the lower electrode 21b in the Y-axis direction (that is, the width of the strip) is substantially the same as the length of a liquid crystal display element group, described above, in the Y-axis direction (that is, the length about eight times the length of the liquid crystal display element 11 in the Y-axis direction).

The emitter section 21c is formed of a ferroelectric material (here, a ternary PMN-PT-PZ material including lead magnesium niobate (PMN), lead titanate (PT), and lead zirconate (PZ)), and is disposed on the upper surface of the lower electrode 21b above the substrate 21a. The emitter section 21c is a thin plate whose thickness direction corresponds to the Z-axis direction, and has substantially the same rectangular shape as the substrate 21a in plan view. Irregularities 21c1 due to the grain boundaries of the ferroelectric material are formed on the upper surface of the emitter section 21c.

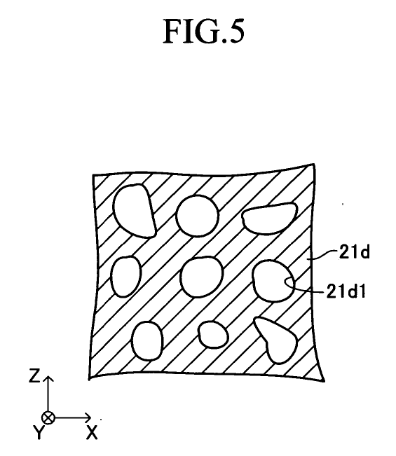

The upper electrode 21d is formed of an electrically conductive material (here, platinum), and is disposed in the form of a layer above the emitter section 21c (on the upper surface of the emitter section 21c) so as to face the lower electrode 21b with the emitter section 21c therebetween. The shape of the upper electrode 21d in plan view is a strip with a long side extending in the Y-axis direction. The length of the upper electrode 21d in the X-axis direction (that is, the width of the strip) is substantially the same as the length of a liquid crystal display element group, described above, in the X-axis direction (that is, the length about eight times the length of the liquid crystal display element 11 in the X-axis direction). A plurality of fine through-holes 21d1 are formed in the upper electrode 21d, as shown in FIGS. 4 and 5. FIG. 5 is an enlarged partial plan view of the upper electrode 21d.

The thickness t of the upper electrode 21d ranges from 0.01 μm or more to 10 μm or less, and, preferably, from 0.05 μm or more to 1 μm or less. A surface corresponding to the peripheries of the fine through-holes 21d1 and facing the emitter section 21c is spaced a predetermined distance apart upward from the emitter section 21c. The maximum distance between the surface corresponding to the peripheries of the through-holes 21d1 (the edges of the through-holes) and facing the emitter section 21c and the emitter section 21c (the upper surface of the emitter section 21c) ranges from more than 0 μm to 10 μm or less, and, preferably, from 0.01 μm or more to 1 μm or less.

The lower electrode 21b, the emitter section 21c, and the upper electrode 21d formed of a platinum resinate paste are monolithically integrated by a baking process. The baking process for the integration reduces the thickness of the layer forming the upper electrode 21d, for example, from 10 μm to 0.1 μm. At this time, the plurality of fine through-holes 21d1 are formed in the upper electrode 21d.

As discussed above, the lower electrode 21b and the upper electrode 21d overlap each other in plan view. Overlapping portions of the lower electrode 21b and the upper electrode 21d form the individual electron-emitting elements 21 together with the emitter section 21c sandwiched between the lower electrode 21b and the upper electrode 21d in the overlapping portions. The lower electrode 21b and the upper electrode 21d are connected to a drive voltage applying circuit 31, which will be described in detail below, so that a drive voltage Vin is applied (a row voltage on lines Sa shown in FIG. 3 to the lower electrode 21b and a column voltage on lines Sb shown in FIG. 3 to the upper electrode 21d). Note that the drive voltage Vin is defined as a potential difference between the lower electrode 21b and the upper electrode 21d on the basis of the lower electrode 21b.

As shown in FIG. 4, the light-emitting section 20B includes a transparent plate 22, a collector electrode 23, and a phosphor 24.

The transparent plate 22 is a thin plate having an upper surface and a lower surface that are parallel to each other, the thickness direction of the plate corresponding to the direction orthogonal to the upper and lower surfaces. The shape of the transparent plate 22 in plan view is rectangular, which is substantially the same as the liquid crystal display 10. The transparent plate 22 is formed of a transparent material (here, glass or an acrylic material). The transparent plate 22 is disposed above the electron-emitting elements 21 (in the positive Z-axis direction) at a predetermined distance apart from the upper surfaces of the electron-emitting elements 21 (the upper surface of the upper electrode 21d). The transparent plate 22 is disposed so that the lower surface of the transparent plate 22 is parallel to the plane defined by the upper electrode 21d (i.e., electron-emitting sections of the electron-emitting elements 21).

The collector electrode 23 is formed of an electrically conductive material (here, a transparent conductive film of indium tin oxide (ITO)). The collector electrode 23 is disposed in the form of a layer on the entire lower surface of the transparent plate 22. A collector voltage applying circuit 32 is connected to the collector electrode 23 to apply a predetermined positive voltage (collector voltage) Vc to the collector electrode 23. Thus, the collector electrode 23 generates an electric field that accelerates and attracts the electrons emitted from the electron-emitting elements 21.

The phosphor 24 is formed in the form of a layer so as to cover the collector electrode 23 on the lower surface of the transparent plate 22. When electrons collide with the phosphor 24, the phosphor 24 is excited by the electrons, and emits white light in the transition from the excitation state to the ground state. A typical example of such a white phosphor is a Y₂O₂S:Tb phosphor. Alternatively, the white phosphor may be manufactured by a mixture of phosphors including a red phosphor (e.g., Y₂O₂S:Eu), a green phosphor (e.g., ZnS:Cu, Al), and a blue phosphor (e.g., ZnS:Ag, Cl). The light emitted from the phosphor 24 is directed upward from the light-emitting section 20B through the transparent plate 22, and enters the liquid crystal display 10.

The space defined between the substrate 21a and the transparent plate 22 is maintained under substantial vacuum (of, preferably, 10² to 10⁻⁶ Pa, and, more preferably, 10⁻³ to 10⁻⁵ Pa). In other words, the substrate 21a and the transparent plate 22, together with sidewalls (not shown) of the electron-emitting device 20A, define an enclosed space. The electron-emitting elements 21 are therefore placed in the enclosed space maintained under substantial vacuum by the space-defining members.

The operation principle of the electron-emitting elements 21 having the structure described above will now be described.

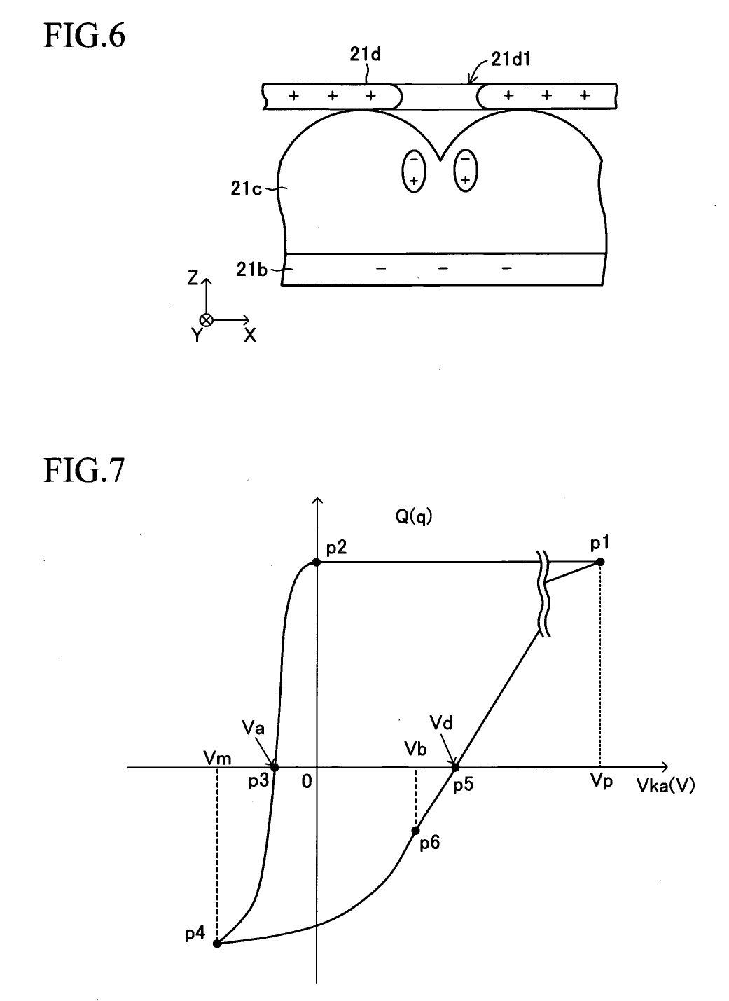

First, the description will start with the state in which, as shown in FIG. 6, an actual potential difference Vka (element voltage Vka) between the lower electrode 21b and the upper electrode 21d on the basis of the potential of the lower electrode 21b is maintained at a predetermined positive voltage Vp and in which all electrons in the emitter section 21c have been emitted so that no electrons are accumulated in the emitter section 21c. In this stage, the negative poles of dipoles of the emitter section 21c are directed toward the upper surface of the emitter section 21c (in the positive Z-axis direction, i.e., toward the upper electrode 21d). This state is a state at a point P1 on the graph shown in FIG. 7. FIG. 7 is a voltage-polarization characteristic graph of the emitter section 21c in which the axis of abscissa denotes the element voltage Vka and the axis of ordinate denotes the charge Q accumulated in the vicinity of the upper electrode 21d.

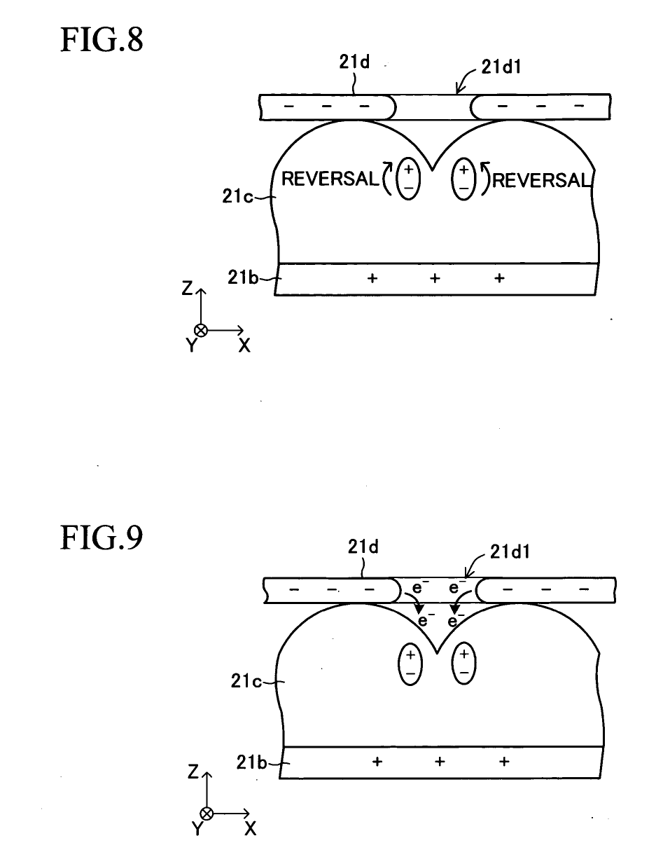

In this state, the drive voltage applying circuit 31 changes the drive voltage Vin to a write voltage (accumulation voltage) Vm, which is a predetermined negative voltage. The element voltage Vka thus decreases toward a point p3 via a point p2 in FIG. 7. When the element voltage Vka reaches a voltage close to a negative coercive field voltage Va (e.g., −10 V) shown in FIG. 7, the direction of the dipoles of the emitter section 21c starts to reverse. That is, as shown in FIG. 8, polarization reversal (negative polarization reversal) starts to occur.

Due to the negative polarization reversal, the electric field increases (i.e., an electric field concentration occurs) at contact sites (triple junctions) between the upper surface of the emitter section 21c, the upper electrode 21d, and the ambient medium (in this case, vacuum) and/or the distal end portions of the upper electrode 21d defining the fine through-holes 21d1. As a result, as shown in FIG. 9, electrons start to be supplied toward the emitter section 21c from the upper electrode 21d.

The supplied electrons are accumulated in the vicinity of portions mainly in the upper part of the emitter section 21c that appear from the fine through-holes 21d1 of the upper electrode 21d and in the vicinity of the edge portions of the upper electrode 21d that define the fine through-holes 21d1 (hereinafter also referred to simply as “in the vicinity of the fine through-holes 21d1”). Then, when the negative polarization reversal is completed after the elapse of a predetermined time, the element voltage Vka rapidly changes toward the predetermined negative voltage Vm and is decreased to the predetermined negative voltage Vm. As a result, the accumulation of electrons is completed (i.e., the accumulation saturation of electrons occurs). This state is a state at a point p4 in FIG. 7.

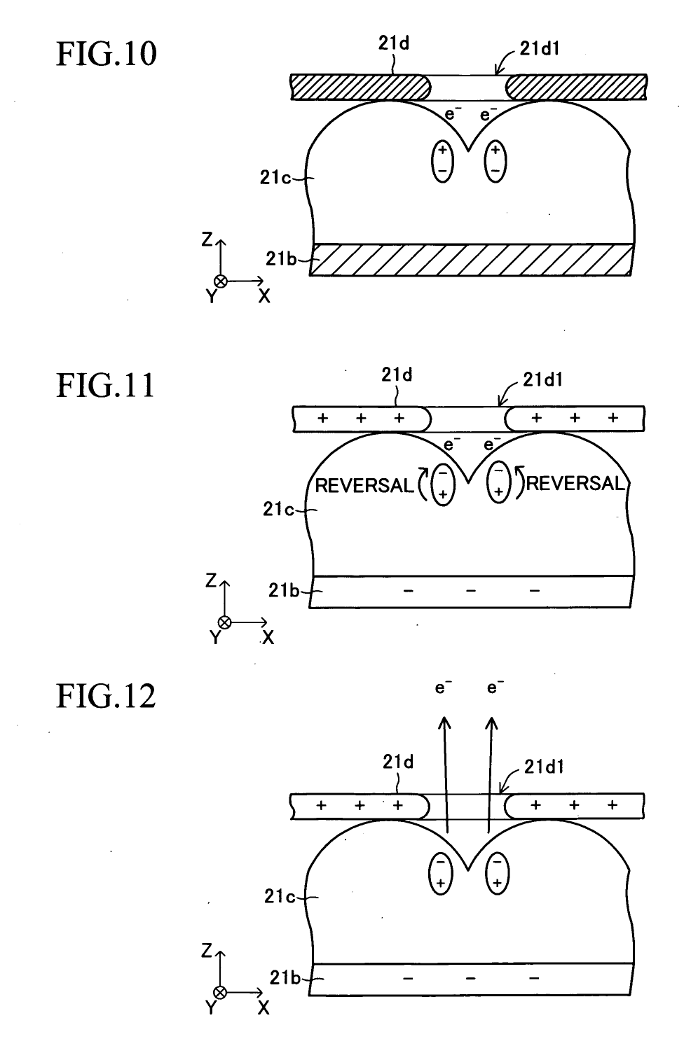

When an electron emission timing arrives, the drive voltage applying circuit 31 changes the drive voltage Vin to an electron emission voltage Vp, which is the predetermined positive voltage. The element voltage Vka thus starts to increase. In this stage, as shown in FIG. 10, the charge state of the emitter section 21c is maintained until the element voltage Vka reaches a voltage Vb (point p6) slightly lower than a positive coercive field voltage Vd (e.g., +50 V) corresponding to a point p5 in FIG. 7.

Then, the element voltage Vka reaches a voltage close to the positive coercive field voltage Vd. Thus, the negative poles of the dipoles start to be turned toward the upper surface of the emitter section 21c. That is, as shown in FIG. 11, the polarization is reversed again (i.e., positive polarization reversal starts to occur). This state is a state near the point p5 in FIG. 7.

Then, the nearer the time of the completion of the positive polarization reversal, the more the dipoles whose negative poles are turned toward the upper surface of the emitter section 21c. As a result, as shown in FIG. 12, the electrons accumulated in the emitter section 21c in the vicinity of the fine through-holes 21d1 start to be emitted upward (in the positive Z-axis direction) through the fine through-holes 21d1 by Coulomb repulsion. Since the large number of fine through-holes 21d1 are defined in the upper electrode 21d, a large number of electrons are emitted in a planar manner through the fine through-holes 21d1. The emitted electrons are applied to the phosphor 24 of the light-emitting section 20B. Thus, the phosphor 24 emits white light. The emitted light is directed upward through the transparent plate 22, and enters the liquid crystal display 10.

When the positive polarization reversal is completed, the element voltage Vka starts to rapidly increase, and electrons are actively emitted. Then, the emission of electrons is completed, and the element voltage Vka reaches the predetermined positive voltage Vp. As a result, the state of the emitter section 21c returns to the initial state shown in FIG. 6 (the state at the point p1 in FIG. 7). What has been described above is a series of operations for the accumulation of electrons (writing of electrons) and the emission of electrons (lighting of the phosphor).

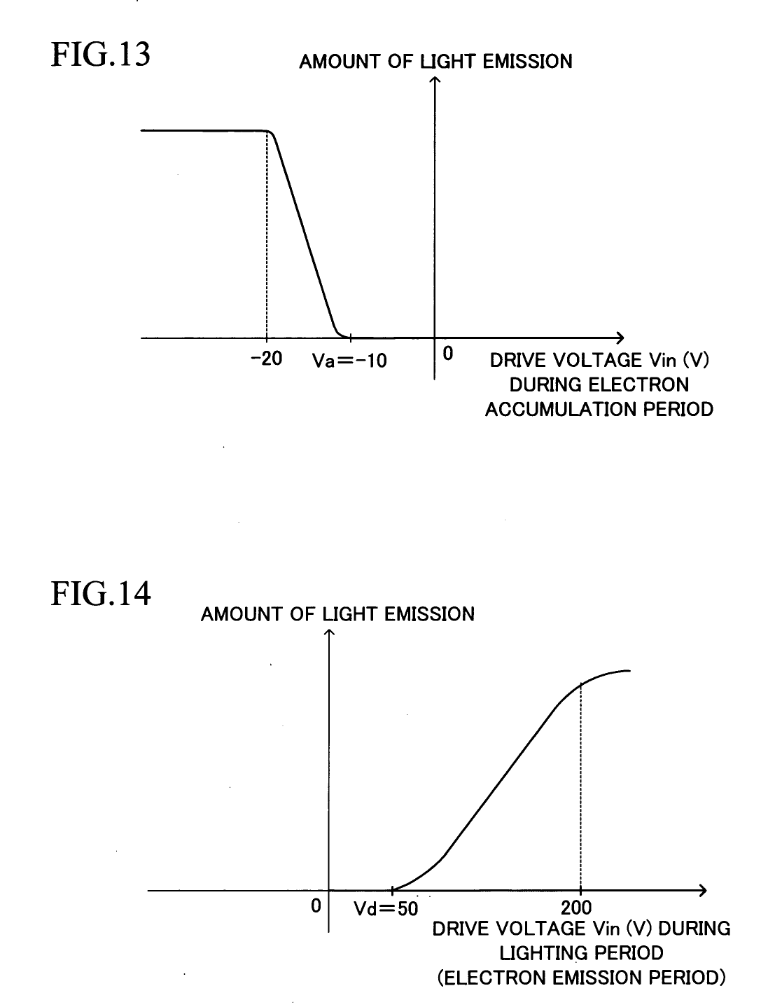

In the electron-emitting elements 21, therefore, negative polarization reversal does not occur unless the drive voltage Vin exceeds below the negative coercive field voltage Va (e.g., −10 V) (i.e., unless the drive voltage Vin becomes a negative voltage with magnitude greater than the absolute value of the negative coercive field voltage Va), and the electrons to be emitted are not accumulated in the emitter section 21c in the vicinity of the fine through-holes 21d1. Thus, the relationship between the write voltage of the electron-emitting elements 21 (the drive voltage Vin during the accumulation of electrons) and the amount of light emission of the phosphor 24 changes as shown in the graph of FIG. 13. As is understood from FIG. 13, the electron-emitting elements 21 are elements capable of accumulating and emitting electrons with respect to a predetermined range of write voltage (a negative voltage in the range of, in this embodiment, −20 to −10 V), wherein the greater the absolute value of the voltage, the more the electrons the elements accumulate and emit.

Further, in the electron-emitting elements 21, positive polarization reversal does not occur unless the drive voltage Vin exceeds above the positive coercive field voltage Vd (e.g., +50 V), and the electrons accumulated in the emitter section 21c in the vicinity of the fine through-holes 21d1 are not emitted. Thus, the relationship between the electron emission voltage of the electron-emitting elements 21 (the drive voltage Vin during the lighting) and the amount of light emission of the phosphor 24 changes as shown in the graph of FIG. 14.

Next, the drive voltage applying circuit 31 will be described in detail. As shown in FIG. 15, the drive voltage applying circuit 31 includes a signal control circuit 31a, a row signal circuit (row selecting circuit) 31b, and a column signal circuit (signal supplying circuit) 31c. In FIG. 15, the individual electron-emitting elements 21 are represented by reference numerals D11, D12, . . . D32, and D33. Note that the electron-emitting element 21 disposed in the x-th row and the y-th column is represented by reference numeral Dxy.

The signal control circuit 31a is connected to a display control circuit 12 for supplying the row scanning signal Sc and the image control signal Sv to the liquid crystal display elements 11 of the liquid crystal display 10, and receives the row scanning signal Sc and the image control signal Sv.

The row signal circuit 31b is connected to the signal control circuit 31a, and receives a row signal control signal Sx. The row signal circuit 31b is further connected to a plurality of row selecting lines LL. Each of the plurality of row selecting lines LL is connected to the lower electrode 21b of the electron-emitting elements 21 in the same row. For example, the row selecting line LL1 is connected to the lower electrode 21b of the elements D11, D12, D13, . . . in the first row; the row selecting line LL2 is connected to the lower electrode 21b of the elements D21, D22, D23, . . . in the second row; and the row selecting line LL3 is connected to the lower electrode 21b of the elements D31, D32, D33, . . . in the third row. In response to the row signal control signal Sx, the row signal circuit 31b applies a row voltage, which will be described below, to the lower electrode 21b of the electron-emitting elements 21 via the plurality of row selecting lines LL.

The column signal circuit 31c is connected to the signal control circuit 31a, and receives a column signal control signal Sy. The column signal circuit 31c is further connected to a plurality of emission signal lines UL. Each of the emission signal lines UL is connected to the upper electrode 21d of the electron-emitting elements 21 in the same column. For example, the emission signal line UL1 is connected to the upper electrode 21d of the elements D11, D21, D31, . . . in the first column; the emission signal line UL2 is connected to the upper electrode 21d of the elements D12, D22, D32, . . . in the second column; and the emission signal line UL3 is connected to the upper electrode 21d of the elements D13, D23, D33, . . . in the third column. In response to the column signal control signal Sy, the column signal circuit 31c applies a column voltage, which will be described below, to the upper electrode 21d of the electron-emitting elements 21 via the plurality of emission signal lines UL.

(Operation)

Next, the operation of the thus constructed liquid crystal display device LD will be described. The display control circuit 12 performs row-scanning, which is known in the display technology using liquid crystal displays, to control the liquid crystal alignment of the liquid crystal display elements 11 (the red liquid crystal elements R, the green liquid crystal elements G, and the blue liquid crystal elements B) so that an image is displayed on the liquid crystal display 10.

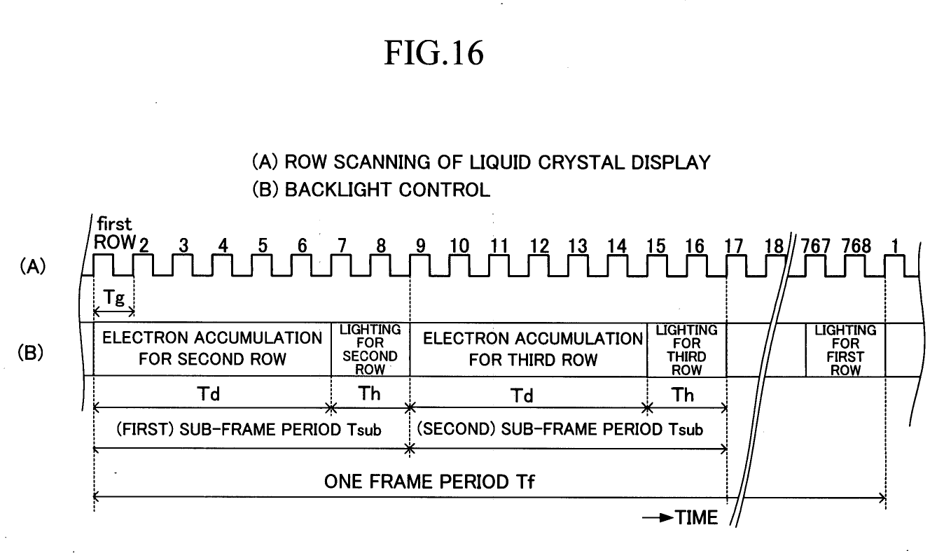

More specifically, the display control circuit 12 sets the row scanning signal Sc for a row to be row-scanned (selected row) to a predetermined voltage, and the row scanning signal Sc for the remaining rows to a different voltage. A voltage based on the image control signal Sv is thus applied only to the liquid crystal display elements 11 in the row to be row-scanned. The display control circuit 12 applies the image control signal Sv so that the liquid crystal display elements 11 in the row to be row-scanned can achieve the individual transmittances for the image to be displayed. When the image control signal Sv is applied, the liquid crystal display elements 11 in the row to be row-scanned start to change the alignment so as to achieve the transmittance based on the image control signal Sv. After about ten milliseconds, the alignment is completed and the constant transmittance is achieved. The row-scanning operation is repeatedly performed for the first to 768th rows in sequence at intervals of a constant time (Tg), as shown in (A) of FIG. 16.

As a result of row-scanning the first to 768th rows, the transmittance of all of the liquid crystal display elements 11 of the liquid crystal display 10 is changed, and a new image of one frame is displayed. The period needed for row-scanning the first to 768th rows is referred to as a “frame period (frame time) Tf”.

Meanwhile, the signal control circuit 31a that controls the backlight 20 performs an electron accumulation (writing) operation and an electron emission operation (light emission from the light-emitting section 20B) in a cycle of a sub-frame period Tsub. The sub-frame period Tsub is a period of time (8·Tg) needed for row-scanning eight rows of the liquid crystal display 10. For example, a sub-frame period Tsub is a period for row-scanning the first to eighth rows of the liquid crystal display 10, and the next sub-frame period Tsub is a period for row-scanning the ninth to 16th rows of the liquid crystal display 10.

The sub-frame period Tsub is therefore a period starting at the time when the row scanning operation for all of the liquid crystal display elements 11 forming a liquid crystal display element group composed of 8 rows by 8 columns of liquid crystal display elements 11 is completed and ending at the time when the time (8·Tg) needed for row-scanning eight (8=768 rows/96 rows=n/N) rows of the liquid crystal display elements 11 has elapsed since the starting time.

More specifically, the signal control circuit 31a recognizes the start of a sub-frame period Tsub on the basis of the row scanning signal Sc input from the display control circuit 12, and sets a negative voltage (write voltage) as the drive voltage Vin for the electron-emitting elements 21 in an identical row corresponding to (facing, with the light-emitting section 20B therebetween) liquid crystal display element groups including a row of the liquid crystal display 10 for which the row-scanning operation is to be started at the end of the sub-frame period Tsub. Thus, electrons start to be accumulated in the emitter section 21c of those electron-emitting elements 21. After an electron emission period Td has elapsed since the start of the sub-frame Tsub, the positive voltage (electron emission voltage) is set as the drive voltage Vin, and the accumulated electrons are emitted so that light is emitted from the phosphor 24.

For example, as shown in FIG. 16, liquid crystal display element groups for which the row-scanning operation is to be started at the end of a sub-frame period (first sub-frame period) Tsub for row-scanning the first to eighth rows of the liquid crystal display 10 are liquid crystal display element groups including the liquid crystal display elements 11 in the ninth row of the liquid crystal display 10. The electron-emitting elements 21 corresponding to those liquid crystal display element groups are the 128 electron-emitting elements 21 belonging to the second row of the electron-emitting device 20A. In the first sub-frame period Tsub, therefore, the signal control circuit 31a causes the electron-emitting elements 21 belonging to the second row of the electron-emitting device 20A to accumulate and emit electrons.

In the first sub-frame period Tsub, the accumulation of electrons in the electron-emitting elements 21 belonging to the second row of the electron-emitting device 20A is completed when a sufficient time has elapsed since the previous row-scanning operation was completed for the liquid crystal display elements 11 in the 16th row, which is the last row to be row-scanned in the liquid crystal display element groups to which the liquid crystal display elements 11 in the ninth row of the liquid crystal display 10 belong.

At the time of completion of the accumulation of electrons in the first sub-frame period Tsub, therefore, all of the plurality of liquid crystal display elements 11 belonging to the liquid crystal display element groups including the liquid crystal display elements 11 in the ninth row of the liquid crystal display 10 are in a state where the alignment is completed and the constant optical transmittance can be achieved. The backlight 20 applies light to those liquid crystal display elements 11 at this timing, and image blur due to delay of the liquid crystal alignment is suppressed.

Similarly, liquid crystal display element groups for which the row-scanning operation is to be started at the end of a sub-frame period (second sub-frame period) Tsub for row-scanning the ninth to 16th rows of the liquid crystal display 10 are liquid crystal display element groups including the liquid crystal display elements 11 in the 17th row of the liquid crystal display 10. The electron-emitting elements 21 corresponding to those liquid crystal display element groups are the 128 electron-emitting elements 21 belonging to the third row of the electron-emitting device 20A. In the second sub-frame period Tsub, therefore, the signal control circuit 31a causes the electron-emitting elements 21 belonging to the third row of the electron-emitting device 20A to accumulate and emit electrons.

Also in the second sub-frame period Tsub, the accumulation of electors is completed when a sufficient time has elapsed since the previous row-scanning operation was completed for the liquid crystal display elements 11 in the 24th row, which is the last row to be row-scanned in the liquid crystal display element groups to which the liquid crystal display elements 11 in the 17th row of the liquid crystal display 10 belong. At the time of completion of the accumulation of electrons in the second sub-frame period Tsub, therefore, all of the liquid crystal display elements 11 belonging to the liquid crystal display element groups including the liquid crystal display elements 11 in the 17th row of the liquid crystal display 10 are in a state where the alignment is completed and the constant optical transmittance can be achieved. The backlight 20 applies light to those liquid crystal display elements 11 at this timing, and image blur due to delay of the liquid crystal alignment is suppressed.

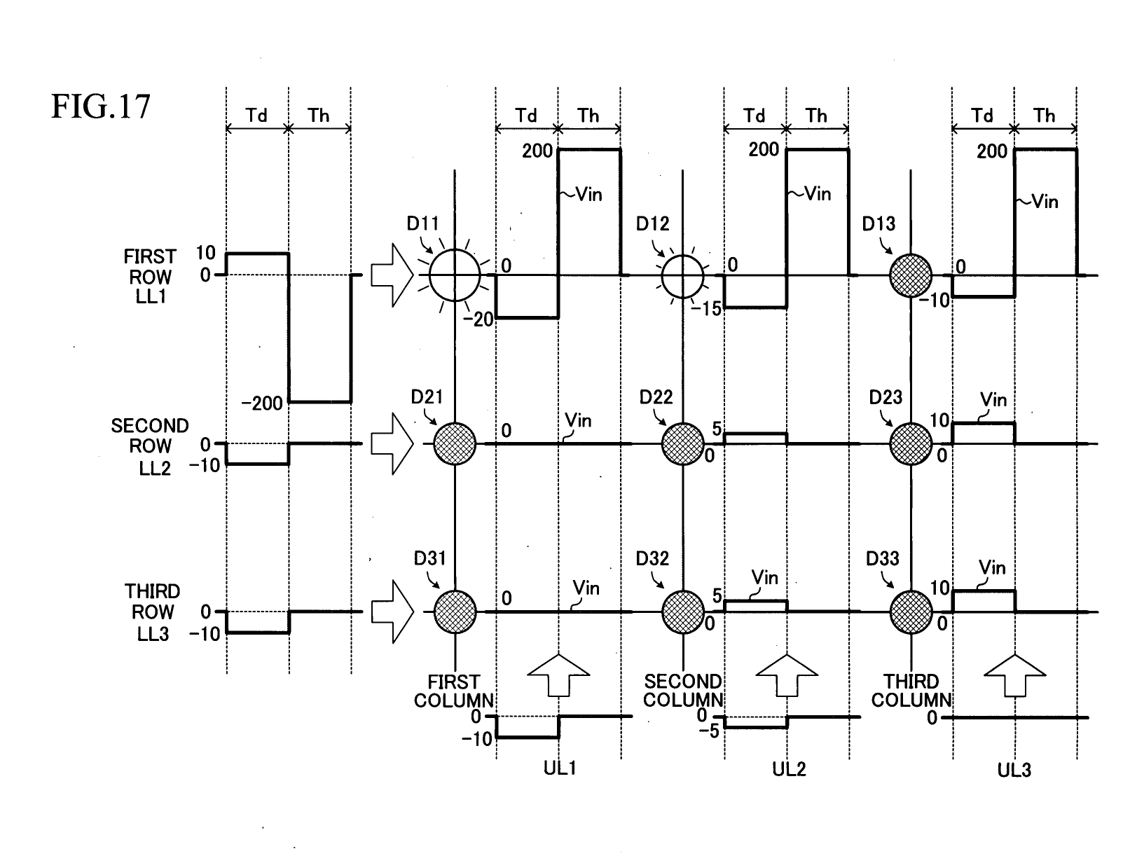

Further, the signal control circuit 31a controls the amount of light emitted from the light-emitting section 20B depending on the brightness of the image to be displayed. The control will be described with reference to FIG. 17 in the context of an example in which light is emitted from the light-emitting section 20B corresponding to the first row of the electron-emitting device 20A.

First, in response to the image control signal Sv input from the display control circuit 12, the signal control circuit 31a determines by calculation an average brightness of an image portion displayed by the liquid crystal display elements 11 belonging to a liquid crystal display element group corresponding to each of the electron-emitting elements 21 (a liquid crystal display element group disposed directly above each of the electron-emitting elements 21) (i.e., the average value of the optical transmittances of those liquid crystal display elements 11).

The description will be continued while it is assumed that an image portion corresponding to the electron-emitting element (D11) located in the first row and the first column of the electron-emitting device 20A is very bright; an image portion corresponding to the electron-emitting element (D12) located in the first row and the second column is intermediately bright, and an image portion corresponding to the electron-emitting element (D13) located in the first row and the third column is only black (without illumination).

As shown in FIG. 17, in the electron accumulation period (writing period) Td in the sub-frame period Tsub, the signal control circuit 31a applies a row voltage of 10 V to the row selecting line LL1, a row voltage of −10 V to the row selecting line LL2, and a row voltage of −10 V to the row selecting line LL3 by means of the row signal circuit 31b. In the electron accumulation period Td, the signal control circuit 31a also applies a column voltage of −10 V to the emission signal line UL1, a column voltage of −5 V to the emission signal line UL2, and a column voltage of 0 V to the emission signal line UL3 by means of the column signal circuit 31c.

As a result, a voltage of 10 V and a voltage of −10 V are applied to the lower electrode 21b and the upper electrode 21d of the electron-emitting element (D11) located in the first row and the first column, respectively, and the drive voltage Vin (write voltage) applied to this electron-emitting element is therefore −20 V. Thus, as is also understood from FIG. 13, a large amount of electrons equal to substantially the amount of saturation are accumulated in the emitter section 21c of the electron-emitting element (D11) located in the first row and the first column. The drive voltage Vin applied to the electron-emitting element (D12) located in the first row and the second column is −15 V. Thus, as is also understood from FIG. 13, an amount of electrons equal to about half the amount of saturation are accumulated in the emitter section 21c of the electron-emitting element (D12) located in the first row and the second column. Meanwhile, the drive voltage Vin applied to the electron-emitting element (D13) located in the first row and the third column is −10 V. Thus, no electrons are accumulated in the electron-emitting element (D13) located in the first row and the third column.

The drive voltages Vin applied to the electron-emitting elements in the second and third rows are as shown in FIG. 17. Given that the drive voltage applied to the element in the x-th row and the y-th column is represented by Vin(x, y), Vin(2, 1)=0 V, Vin(2, 2)=5 V, Vin(2, 3)=10 V, Vin(3, 1)=0 V, Vin(3, 2)=5 V, and Vin(3, 3)=10 V are obtained. Since those drive voltages Vin are voltages greater than the negative coercive field voltage Va, namely, −10 V, no electrons are accumulated in the emitter section 21c of those electron-emitting elements 21.

Then, an electron emission period (lighting period) Th arrives after the elapse of the electron accumulation period Td, and, during the electron emission period Th, the signal control circuit 31a applies a row voltage of −200 V to the row selecting line LL1, a row voltage of 0 V to the row selecting line LL2, and a row voltage of 0 V to the row selecting line LL3 by means of the signal circuit 31b. In the electron emission period Th, the signal control circuit 31a also applies a column voltage of 0 V to all of the emitting signal lines UL1 through UL3 by means of the column signal circuit 31c.

The drive voltages Vin applied to the electron-emitting elements (D11, D12, and D13) in the first row are therefore 200 V.

As a result, a large amount of electrons are emitted from the electron-emitting element (D11) in which a large amount of electrons are accumulated, and the phosphor 24 disposed above this electron-emitting element emits a large amount of light. The image portion corresponding to the electron-emitting element (D11) is therefore displayed very brightly.

From the electron-emitting element (D12) in which an amount of electrons equal to half the amount of saturation are accumulated, a smaller amount of electrons than the amount of electrons emitted from the electron-emitting element (D11) are emitted. The phosphor 24 disposed above this electron-emitting element emits an intermediate amount of light. The image portion corresponding to the electron-emitting element (D12) is therefore displayed with normal brightness.

From the electron-emitting element (D13) located in the first row and the third column in which no electrons are accumulated, no electrons are emitted. The image portion corresponding to the electron-emitting element (D13) is therefore displayed in black.

The drive voltages Vin applied to the electron-emitting elements in the second and third rows are 0 V in the electron emission period Th, and, in addition, those elements have no electrons accumulated therein. Since no electrons are emitted from those elements, the image portions corresponding to those elements are displayed only in black.

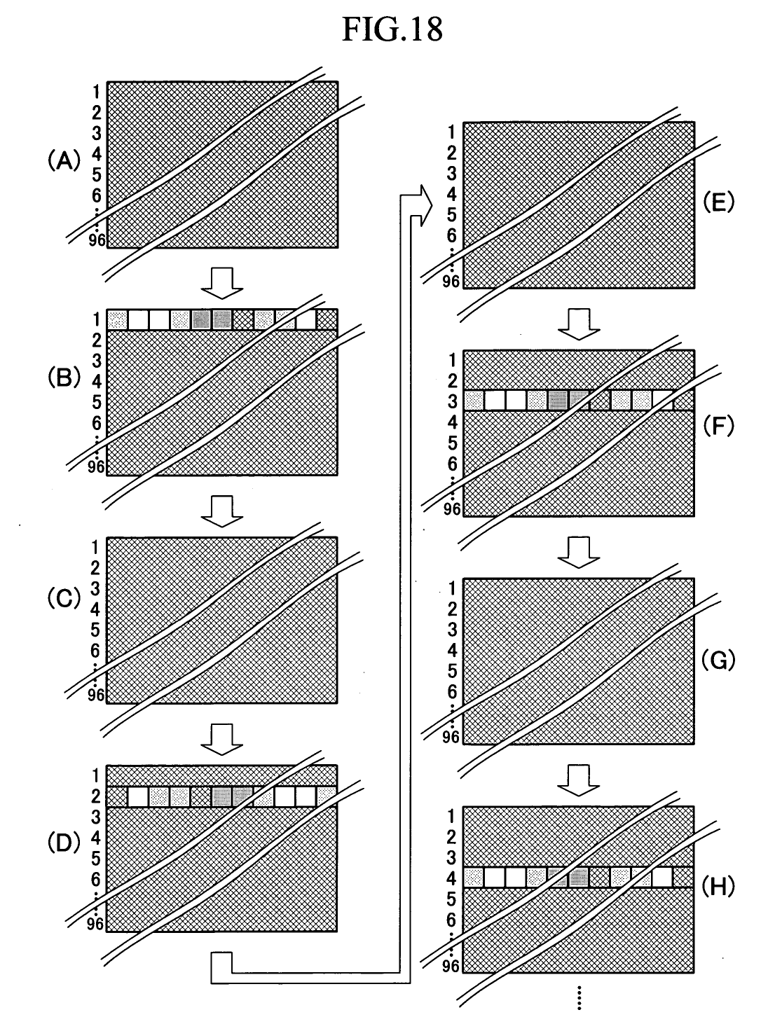

FIG. 18 is a schematic diagram showing the states, in plan view, of the light-emitting section 20B obtained by the control described above. In (A) of FIG. 18, the state of the light-emitting section 20B during the electron accumulation period Td for the electron-emitting elements 21 belonging to the first row is illustrated. In the electron accumulation period Td, the light-emitting section 20B does not emit light. Then, in the electron emission period Th for the electron-emitting elements 21 belonging to the first row, as shown in (B) of FIG. 18, emit the electrons accumulated in the electron accumulation period Td, and the portions of the light-emitting section 20B corresponding to the electron-emitting elements 21 belonging to the first row emit light with brightness according to the amount of electron emission of the electron-emitting elements 21 belonging to the first row.

Subsequently, likewise, the light-emitting section 20B does not emit light in the electron accumulation period Td, and, then, in the electron emission period Th, the portions of the light-emitting section 20B corresponding to the electron-emitting elements 21 belonging to a specified row in which electrons are accumulated in the previous electron accumulation period Td emit light with brightness according to the amount of electron emission of the individual electron-emitting elements 21 belonging to the specified row. After the emission of light is finished, the row-scanning operation is started for the liquid crystal display elements 11 of the liquid crystal display 10 corresponding to the portions in which the emission of light has been finished. In other words, during the last sub-frame period in a period from the time when the row-scanning operation is performed on the liquid crystal display elements 11 to be row-scanned last in the above-described liquid crystal display element groups to the next time the row-scanning operation for the same crystal display elements 11 is started (actually, in a period until the next time the row-scanning operation is started for the liquid crystal display elements 11 to be row-scanned first in that liquid crystal display element groups), the electron-emitting elements 21 corresponding to the same liquid crystal display elements 11 emit electrons, and the corresponding portions of the light-emitting section 20B emit light.

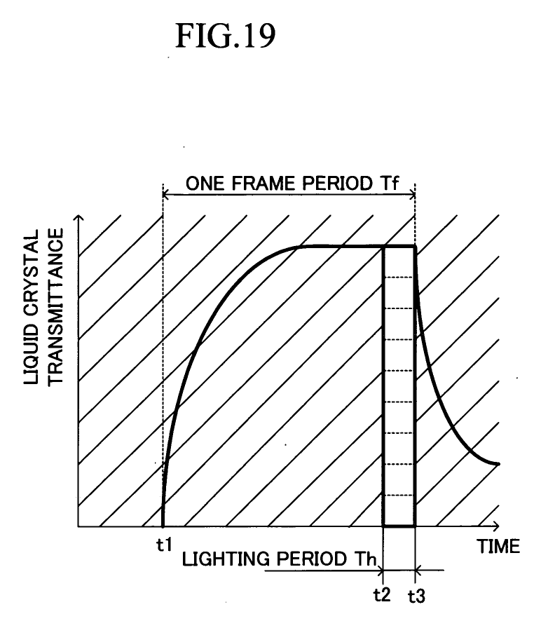

In the backlight for the liquid crystal display and the method for controlling the backlight according to the embodiment of the present invention described above, therefore, as also shown in FIG. 19, light is applied to liquid crystal display elements that are in a state where the liquid crystal alignment is completed and the transmittance is constant. It is therefore possible to suppress image blur due to delay of the liquid crystal alignment. In FIG. 19, at times t1 and t3, consecutive iterations of the row-scanning operation are started for the liquid crystal display elements 11 in a specified row of the liquid crystal display 10 (a row to be row-scanned first in the liquid crystal display element groups).

Further, in the backlight for the liquid crystal display and the method for controlling the backlight, no excessive light is emitted from the phosphor facing liquid crystal display elements that are to represent a dark area of an image, and no excessive light enters those liquid crystal display elements. A liquid crystal display device with low power consumption is therefore provided.

Furthermore, as is also understood from FIG. 19, the electron-emitting device allows for multiple types of the amount of light emission (multiple ranges of the amount of light emission indicated by broken lines in FIG. 19). The number of gradation levels that can be reproduced by the liquid crystal display device (liquid crystal display element groups) is given by the product of the number of transmittance levels (transmittance ranges) available from the individual liquid crystal display elements 11 and the number of ranges of the amount of light emission. That is, the gradation reproduction performance of the system is considerably improved.

The present invention is not limited to the embodiments described above, and a variety of modifications may be made without departing from the scope of the present invention. For example, in the above-described embodiment, the single phosphor 24 is provided for the plurality of electron-emitting elements 21. A single phosphor may be provided for each of the electron-emitting elements 21.

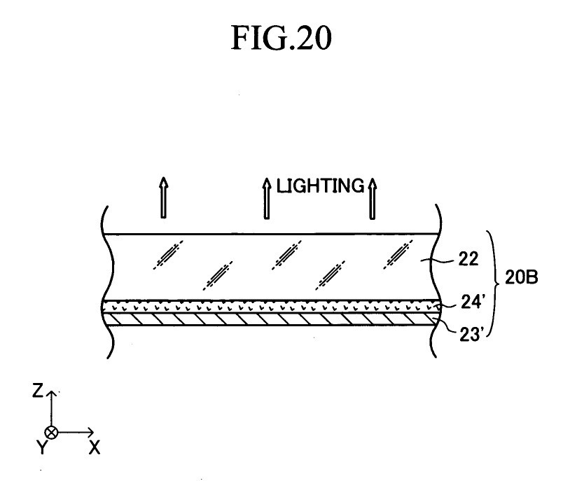

As shown in FIG. 20, the light-emitting section 20B may have a structure in which a phosphor 24′ is pre-formed on the lower surface of the transparent plate 22 (the surface facing the upper electrode 21d) and a collector electrode 23′ formed of an aluminum thin film of about 100 to 200 nm thickness is then formed so as to cover the phosphor 24′. In this case, electrons accelerated by an electric field generated by applying the collector voltage Vc reach the phosphor 24′ through the collector electrode 23′. With the structure, the collector electrode 23′ functions as a mirror for reflecting the light emitted from the phosphor 24′ toward the transparent plate 22. Thus, the light emitted from the phosphor 24′ can be efficiently transmitted to the outside.

Further, the phosphor 24 may be formed so as to be brought into contact with the upper electrode 21d on a surface of the upper electrode 21d opposite to the emitter section 21c. Therefore, a light-emitting element in which electrons emitted through the fine through-holes 21d1 of the upper electrode 21d collide with a phosphor disposed directly above the upper electrode 21d, thereby exciting the phosphor to emit light is constructed.

Furthermore, an electron-emitting device with a structure in which completely independent electron-emitting elements each including a lower electrode, an emitter section, and an upper electrode are arranged in a matrix of N rows and M columns on a substrate, the lower electrodes of the electron-emitting elements in an identical row being connected by an electrical conductor and the upper electrodes of the electron-emitting elements in an identical column being connected by an electrical conduct, may be used.

An upper electrode composed of an aggregate of flake-like materials (such as graphite) or an aggregate of electrically conductive materials including flake-like materials may be employed. Since an aggregate of such materials inherently has portions in which flakes are spaced apart from each other, those portions can be used as fine through-holes of the upper electrode without performing heat treatment, such as baking. Further, an organic resin and a metal thin film may be formed in the form of layers in the stated order on an emitter section and then baked to burn off the organic resin to form fine through-holes in the metal thin film, thereby forming an upper electrode.

1. A backlight used for a liquid crystal display including a plurality of liquid crystal display elements arranged in a matrix of n rows and m columns, in which constant-time row scanning is performed for all rows in row order in a frame period to change the optical transmittance of the plurality of liquid crystal display elements, thereby switching an image to be displayed by the plurality of liquid crystal display elements, the backlight comprising:
an electron-emitting device comprising a plurality of electron-emitting elements including:
an emitter section formed of a dielectric material;
a lower electrode disposed below the emitter section; and
an upper electrode disposed above the emitter section so as to face the lower electrode with the emitter section therebetween, the upper electrode having a plurality of fine through-holes,
wherein the electron-emitting elements accumulate a large number of electrons in the emitter section when a predetermined write voltage is applied between the upper electrode and the lower electrode, and emit the electrons accumulated in the emitter section through the fine through-holes from the emitter section when a predetermined electron emission voltage is applied between the upper electrode and the lower electrode, and
the electron-emitting elements are arranged in a matrix so that each of the electron-emitting elements faces each of liquid crystal display element groups including a plurality of the liquid crystal display elements of the liquid crystal display that are adjacent to each other;
a phosphor disposed between the upper electrode of the electron-emitting elements and the liquid crystal display so as to face the upper electrode, the phosphor emitting light toward the liquid crystal display by collisions with electrons; and
a drive voltage applying circuit for, in a period from the time when the row scanning for one of the liquid crystal display element groups is finished after which the optical transmittance of liquid crystal display elements belonging to the one liquid crystal display element group becomes constant to the time when the row scanning for the one liquid crystal display element group is started next time, applying the electron emission voltage to an electron-emitting element in the plurality of electron-emitting elements for a predetermined time, the electron-emitting element facing the one liquid crystal display element group, and applying the write voltage in a period until the next time when the electron emission voltage is applied again to the electron-emitting element to which the electron emission voltage is applied.

2. The backlight according to claim 1, wherein the value n is a multiple of an integer N of 2 or more,
the value m is a multiple of an integer M of 2 or more,
the liquid crystal display element groups are arranged in a matrix of n/N rows and m/M columns, n/N being given by dividing n by N, m/M being given by dividing m by M, and
the drive voltage applying circuit is configured to, in a sub-frame period starting at the time when the row scanning for all of the liquid crystal display elements forming one of the liquid crystal display element groups is completed and ending at the time when a time needed for the row scanning for the n/N rows has elapsed since the starting time, apply the write voltage and the electron emission voltage to the electron-emitting element facing the liquid crystal display element group including the liquid crystal display elements for which the row scanning is to be started at the end of the sub-frame period.

3. The backlight according to claim 1, wherein the drive voltage applying circuit is configured to set the write voltage to a voltage according to the optical transmittance of the plurality of liquid crystal display elements belonging to the liquid crystal display element group facing the electron-emitting element to which the write voltage is applied.

4. A lighting control method for a backlight used for a liquid crystal display including a plurality of liquid crystal display elements arranged in a matrix of n rows and m columns, in which constant-time row scanning is performed for all rows in row order in a frame period to change the optical transmittance of the plurality of liquid crystal display elements, thereby switching an image to be displayed by the plurality of liquid crystal display elements, the backlight comprising an electron-emitting device comprising a plurality of electron-emitting elements including an emitter section formed of a dielectric material, a lower electrode disposed below the emitter section, and an upper electrode disposed above the emitter section so as to face the lower electrode with the emitter section therebetween, the upper electrode having a plurality of fine through-holes, wherein the electron-emitting elements accumulate a large number of electrons in the emitter section when a predetermined write voltage is applied between the upper electrode and the lower electrode, and emit the electrons accumulated in the emitter section through the fine through-holes from the emitter section when a predetermined electron emission voltage is applied between the upper electrode and the lower electrode, and the electron-emitting elements are arranged in a matrix so that each of the electron-emitting elements faces each of liquid crystal display element groups including a plurality of the liquid crystal display elements of the liquid crystal display that are adjacent to each other; and a phosphor disposed between the upper electrode of the electron-emitting elements and the liquid crystal display so as to face the upper electrode, the phosphor emitting light toward the liquid crystal display by collisions with electrons,
the lighting control method comprising, in a period from the time when the row scanning for one of the liquid crystal display element groups is finished after which the optical transmittance of liquid crystal display elements belonging to the one liquid crystal display element group becomes constant to the time when the row scanning for the one liquid crystal display element group is started next time, applying the electron emission voltage to an electron-emitting element in the plurality of electron-emitting elements for a predetermined time, the electron-emitting element facing the one liquid crystal display element group, and applying the write voltage in a period until the next time when the electron emission voltage is applied again to the electron-emitting element to which the electron emission voltage is applied.

5. The lighting control method for the backlight according to claim 4, wherein the value n is a multiple of an integer N of 2 or more, the value m is a multiple of an integer M of 2 or more, the liquid crystal display element groups are arranged in a matrix of n/N rows and m/M columns, n/N being given by dividing n by N, m/M being given by dividing m by M, and
in a sub-frame period starting at the time when the row scanning for all of the liquid crystal display elements forming one of the liquid crystal display element groups is completed and ending at the time when a time needed for the row scanning for the n/N rows has elapsed since the starting time, the write voltage and the electron emission voltage are applied to the electron-emitting element facing the liquid crystal display element group including the liquid crystal display element for which the row scanning is to be started at the end of the sub-frame period.

6. The lighting control method for the backlight according to claim 4, wherein the write voltage is set to a voltage according to the optical transmittance of the plurality of liquid crystal display elements belonging to the liquid crystal display element group facing the electron-emitting element to which the write voltage is applied.
